(19) United States
(12) Patent Application Publication
(10) Pub. No.: US 2018/0134008 A1
(43) Pub. Date: May 17, 2018

(54) SEMI-FINISHED PRODUCT AND USE THEREOF

(71) Applicants: THYSSENKRUPP STEEL EUROPE AG, Duisburg (DE); thyssenkrupp AG, Essen (DE)

(72) Inventors: Lars BODE, Düsseldorf (DE); Ralf SÜNKEL, Ratingen (DE)

(73) Assignees: THYSSENKRUPP STEEL EUROPE AG, Duisburg (DE); thyssenkrupp AG, Essen (DE)

(21) Appl. No.: 15/564,022

(22) PCT Filed: Feb. 26, 2016
(86) PCT No.: PCT/EP2016/054047

§ 371 Date: Oct. 3, 2017

(30) Foreign Application Priority Data
Apr. 8, 2015 (DE) 10 2015 206 183.3

(51) Int. Cl. B32B 15/01; B62D 29/00

(52) U.S. Cl. CPC B32B 15/011; B62D 29/007

(57) ABSTRACT

A strip-shaped, plate-shaped, or sheet-shaped semi-finished product may include a particle-reinforced steel material. The particle-reinforced steel material may be connected integrally and over an entire surface area on one or both sides to at least one layer comprised of a non-particle-reinforced metal material. The at least one layer may have a thickness of between 0.2% and 20% of an overall thickness of the semi-finished product and, in some cases, between 0.5% and 15%. The non-particle-reinforced metal material may comprise steel, structural steel, or high-grade steel, for instance. Further, the semi-finished product may be produced by way of cladding or casting.

The invention relates to a strip-shaped, plate-shaped or sheet-shaped semi-finished product comprising a particle-reinforced steel material, and also to a corresponding use of the semi-finished product.

There is enormous pressure on automobile manufacturers to have to lower the CO2 emissions particularly of passenger cars over the next few years so as not to be prosecuted with fines. One possible way of lowering the CO2 emission consists inter alia in reducing the vehicle weight. On account of increasing safety demands, it is also not possible to rule out a situation in which, in future, additional parts or components have to be installed in the vehicle in order to satisfy these safety demands, and this in turn is contradictory to the desired reduction of the overall weight of the vehicle. One possible way of saving weight is, for example, to design or to construct the body, frame and/or the chassis of a vehicle even lighter, through lightweight and innovative materials compared to the materials conventionally used. It is thereby possible, for example, for conventional materials specific to a component to be replaced by lighter materials with comparable properties.

By way of example, particle-reinforced, high-strength steels, reinforced in particular with TiC and TiB₂ particles and having a low density and a relatively high modulus of elasticity, can be configured in thinner form, with consistent properties, than conventional steels, and the reduction of the material thickness makes it possible to have a positive influence on the overall weight of the component, or of the vehicle. Steel materials of this type are outstandingly suitable for the automotive industry. Steel materials of the generic type are known in the prior art, and an exemplary embodiment is disclosed in the European laid-open specification 2 703 509.

The production of particle-reinforced steel materials with particles finely dispersed in the steel matrix is likewise known among experts (cf. also EP 2 703 509 A1). It is possible to influence the distribution of the particles within the steel matrix only to a limited extent or with a high outlay, and therefore it is not possible to rule out a situation in which the particles also collect or settle close to the surface or directly at/on the surface during the production process. The particles used are generally harder than the matrix material, and therefore, during production to form the end product, it may be the case that the hard particles protrude out of the surface plane of the steel matrix, as a result of which the shaping tools, for example in the steel mill during production and also in the pressing plant during further processing, can wear faster in the region of contact, or are subject to high abrasive wear.

It is an object of the present invention to provide a semi-finished product made of a particle-reinforced steel material which makes it possible to substantially reduce, in particular prevent, the abrasive wear at the shaping tools, and also to specify a corresponding use of the semi-finished product.

The object is achieved in that the particle-reinforced steel material is connected integrally and over the entire surface area on one or both sides to at least one layer made of a non-particle-reinforced metal material.

The inventors have determined that the provision of at least one layer made of a non-particle-reinforced metal material which is connected integrally and over the entire surface area on one or both sides to the particle-reinforced steel material makes it possible to ensure that no particles are present in the region close to the surface, and that the at least one layer made of a non-particle-reinforced metal material takes on the function of a barrier and/or protective layer. To reinforce the steel material, it is possible to use all suitable particles, in particular ceramic particles, for example SiC, Al₂O₃, TiC, ZrO₂ and/or TiB₂ particles, individually or in combination, these being dispersed in the steel matrix, depending on the quality of the particles (type, size), with a proportion of between 5 and 40% by weight, in particular with a proportion of between 10 and 35% by weight, preferably with a proportion of between 15 and 30% by weight.

According to a first configuration of the semi-finished product according to the invention, the at least one layer made of the non-particle-reinforced metal material has a material thickness of between 0.2% and 20%, in particular of between 0.5% and 15%, with respect to the overall material thickness of the semi-finished product. The non-particle-reinforced metal material provided as the barrier and/or protective layer should be dimensioned in terms of material thickness in such a manner that firstly the properties of the particle-reinforced steel material are substantially not negatively affected, with the material thickness of the at least one layer amounting to at most 20%, in particular at most 15%, preferably at most 10%, with respect to the overall material thickness of the semi-finished product, and secondly to ensure that the particles in the particle-reinforced steel material do not protrude out of the surface of the semi-finished product, with the material thickness of the at least one layer amounting to at least 0.2%, in particular at least 0.5%, preferably at least 1%, with respect to the overall material thickness of the semi-finished product.

According to a further configuration of the semi-finished product according to the invention, the non-particle-reinforced metal material consists of a steel material, for example of a structural steel or a high-grade steel. Depending on the use of the semi-finished product according to the invention, structural steels are suitable as non-particle-reinforced steel materials since they can be produced relatively cost-effectively. If high-grade steels are used as non-particle-reinforced steel materials, in addition to improving the appearance, the layer or layers make it possible, depending on the high-grade steel material, to provide the semi-finished product with corrosion protection, without providing an additional coating. It goes without saying that other steel materials can also be used, depending on the use. By way of example, an organic and/or inorganic coating, preferably a zinc-based coating, can also be applied to the outer side of the semi-finished product according to the invention.

According to a further configuration of the semi-finished product according to the invention, the semi-finished product is produced by means of cladding, in particular roll cladding, or by means of casting. It is preferable for the semi-finished product according to the invention to be produced by means of hot roll cladding, as is disclosed by way of example in the German patent specification 10 2005 006 606. Reference is made to this patent specification, the contents of which are hereby incorporated in this application.

Alternatively, the semi-finished product according to the invention can be produced by means of casting, with one possible way for producing it being disclosed in the Japanese laid-open specification 03 133 630. The production of metallic composites is prior art.

According to a further aspect, the invention relates to the use of the semi-finished product according to the invention. The semi-finished product according to the invention is used in particular after shaping to form a part or component for a load-bearing construction. Possible load-bearing constructions are frames, subframes, for example in vehicle construction (passenger vehicles, commercial vehicles along with trailers) or railroad construction, ship construction or air and space travel, but also in the construction sector, for example pillars.

1.-6. (canceled)

7. A semi-finished product that is strip-shaped, plate-shaped, or sheet-shaped, the semi-finished product comprising a particle-reinforced steel material that is connected integrally and over an entire surface area on one or both sides to at least one layer comprised of a non-particle-reinforced metal material.

8. The semi-finished product of claim 7 wherein the at least one layer has a thickness of between 0.2% and 20% of an overall material thickness of the semi-finished product.

9. The semi-finished product of claim 7 wherein the at least one layer has a thickness of between 0.5% and 15% of an overall material thickness of the semi-finished product.

10. The semi-finished product of claim 7 wherein the non-particle-reinforced metal material comprises steel.

11. The semi-finished product of claim 7 wherein the non-particle-reinforced metal material comprises structural steel.

12. The semi-finished product of claim 7 wherein the non-particle-reinforced metal material comprises high-grade steel.

13. The semi-finished product of claim 7 produced by way of cladding.

14. The semi-finished product of claim 7 produced by way of casting.

15. A load-bearing construction component that comprises the semi-finished product of claim 7.

16. The load-bearing construction component of claim 15 configured for use in vehicle construction, ship construction, or air and space travel.
